(19) United States
(12) Patent Application Publication
(10) Pub. No.: US 2017/0221247 A1
(43) Pub. Date: Aug. 3, 2017

(54) DISPLAY OF OVERLAYS AND EVENTS IN AUGMENTED REALITY USING GRAPH TRAVERSAL

(71) Applicant: AURASMA LIMITED, Bracknell, Berkshire (GB)

(72) Inventors: Robert Paul Severn, San Francisco, CA (US); David Stone, Alameda, CA (US); Matthew Sullivan, Cambridge (GB)

(73) Assignee: AURASMA LIMITED, Bracknell, Berkshire (GB)

(21) Appl. No.: 15/515,270

(22) PCT Filed: Sep. 29, 2014
(86) PCT No.: PCT/EP2014/070778

§ 371 Date: Mar. 29, 2017

(51) Int. Cl. G06T 11/60; G06F 3/0482; G06Q 30/02; G06T 19/00

(52) U.S. Cl. CPC G06T 11/60; G06T 19/006; G06F 3/0482; G06Q 30/0269

(57) ABSTRACT

Examples of techniques to display overlays and events in augmented reality using graph traversal techniques are disclosed. In one example implementation according to aspects of the present disclosure, an event is associated with each of a plurality of augmented reality overlays. The plurality of augmented reality overlays and associated events is then displayed, using graph traversal techniques, as a graphical representation.

### BACKGROUND

Augmented reality platforms provide the ability to overlay digital media content (e.g., images, videos, three-dimensional models, etc.) onto a trigger image. The trigger image represents an image or other graphical representation that, when scanned by an augmented reality enabled device (e.g., a mobile phone, smart phone, tablet computing device, etc.) using image recognition, activates digital media content to be displayed on the augmented reality enabled device A variety of digital media content may be displayed concurrently, in succession, or in similar combinations on the augmented reality enabled device.

### BRIEF DESCRIPTION OF THE DRAWINGS

The following detailed description references the drawings, in which:

FIG. 1 illustrates a block diagram of a computing system to graphically display overlays and associated events in augmented reality according to examples of the present disclosure;

FIG. 2 illustrates a block diagram of another computing system to graphically display overlays and associated events in augmented reality according to examples of the present disclosure:

FIG. 3 illustrates a block diagram of a computer-readable storage medium storing instructions to graphically display overlays and associated events in augmented reality according to examples of the present disclosure;

FIG. 4 illustrates a flow diagram of a method to graphically display overlays and associated events in augmented reality according to examples of the present disclosure;

FIG. 5 illustrates a flow diagram of a method to graphically display overlays and associated events in augmented reality according to examples of the present disclosure; and

FIG. 6 illustrates a graphical representation of overlays and associated events as may be displayed using the techniques described according to examples of the present disclosure.

### DETAILED DESCRIPTION

Augmented reality (AR) platforms may be used in sales, marketing, advertising, and other similar situations. For example, an automobile manufacture may utilize augmented reality platforms by enabling a customer or potential customer to scan a trigger image, such as the car manufacturer's logo, to learn more about the manufacturer and/or a particular automobile. If a user scans the trigger image, the user may then be provided with an augmented reality experience of watching a video about the manufacturer's newest car. The augmented reality experience may also provide additional information, such as product specifications, and/or options to the, user, such as a social media link or links to share the video.

Augmented reality experiences (also referred to as “auras ”) may be tailored for specific groups (known as “targeting groups”). For example, different AR experiences may be used depending on a variety of factors such as location, age, sex, preferences, etc. In one such example, a targeting group may target males 18-29 years of age, while another targeting, group may target females 13-17. These targeting groups are useful to advertisers and marketers, for example, so that content overlays (i.e., digital content to be displayed on the user's device) can be delivered with the targeting group individuals in mind.

Designers of augmented reality platforms rely on testing the augmented reality experiences during the design process (for example, when initially designing the AR experience or when incorporating changes to the AR experience). However, quickly testing changes to an AR experience that a designer is actively testing is difficult when incorporating changes to the AR experience for different targeting groups. This is because each experience is launched by the same trigger image. Moreover, it may be difficult for a designer of an AR experience to understand how end users are interacting with the AR experience. More particularly, it is difficult for designers of AR experiences to visualize what is visible in the AR experience at any given moment in time, and what a user's experience is like as the user navigates through the AR experience. Consequently, it is difficult for a designer to adapt the AR experience without analytics describing the users' interactions with the AR experience.

Various implementations are described below by referring to several examples of techniques to display overlays and events in augmented reality using graph traversal techniques are disclosed. In one example implementation according to aspects of the present disclosure, an event is associated with each of a plurality of augmented reality overlays. The plurality of augmented reality overlays and associated events is then displayed, using graph traversal techniques, as a graphical representation.

In some implementations, the techniques described herein provide simple visualizations of user interactions with an AR experience. Consequently, an AR experience may be adapted, making the AR experience more valuable to marketers, advertisers, and others who may utilize the AR experience. The present techniques also provide a simple display of what is visible at any given time to an end user and further provide for easy navigation of the flow of the AR experience. These and other advantages will be apparent from the description that follows.

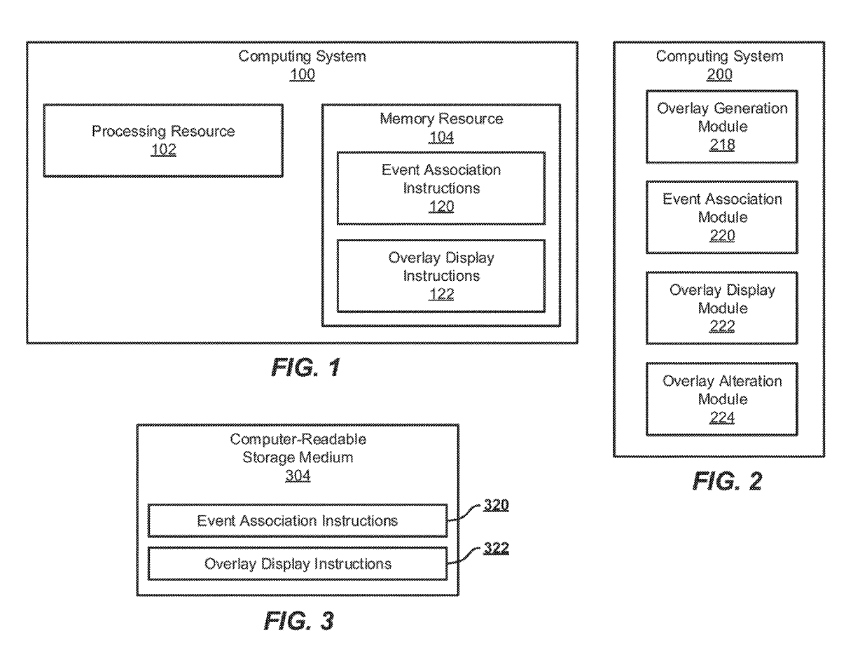

FIGS. 1-3 include particular components, modules, instructions etc. according to various examples as described herein. In different implementations, more, fewer, and/or other components, modules, instructions, arrangements of components/modules/instructions, etc. may be used according to the teachings described herein. In addition, various components, modules, etc. described herein may be implemented as instructions stored on a computer-readable storage medium, hardware modules, special-purpose hardware (e.g., application specific hardware, application specific integrated circuits (ASICs), embedded controllers, hardwired circuitry, etc.), or some combination or combinations of these.

Generally, FIGS. 1-3 relate to components and modules of a computing system, such as computing system 100 of FIG. 1 and/or computing system 200 of FIG. 2. It should be understood that the computing systems 100 and 200 may include any appropriate type of computing system and/or computing device, including for example smartphones, tablets, desktops, laptops, workstations, servers, smart monitors, smart televisions, digital signage, scientific instruments, retail point of sale devices, video walls, imaging devices, peripherals, networking equipment, or the like.

FIG. 1 illustrates a block diagram of a computing system to graphically display overlays and associated events in augmented reality according to examples of the present disclosure. The computing system 100 may include a processing resource 102 that represents generally any suitable type or form of processing unit or units capable of processing data or interpreting and executing instructions. The processing resource 102 may be one or more central processing units (CPUs), microprocessors, and/or other hardware devices suitable for retrieval and execution of instructions. The instructions may be stored, for example, on a non-transitory tangible computer-readable storage medium, such as memory resource 104 (as well as computer-readable storage medium 304 of FIG. 3), which may include any electronic, magnetic, optical, or other physical storage device that store executable instructions. Thus, the memory resource 104 may be, for example, random access memory (RAM), electrically-erasable programmable read-only memory (EPPROM), a storage drive, an, optical disk, and any other suitable type of volatile or non-volatile memory that stores instructions to cause a programmable processor to perform the techniques described herein. In examples, memory resource 104 includes a main memory, such as a RAM in which the instructions may be stored during runtime, and a secondary memory, such as a nonvolatile memory in which a copy of the instructions is stored.

Alternatively or additionally, the computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

In this example, it should be appreciated that the computing system 100 enables a content creation user to create and adapt an augmented reality experience, which may be consumed by users of user computing devices (i.e., computing systems and/or computing devices other than computing system 100).

To facilitate the creation and adaptation of an AR experience, the computing system 100 may include event association instructions 120 and overlay display instructions 122. The instructions 120, 122 may be processor executable instructions stored on a tangible memory resource such as memory resource 104, and the hardware may include processing resource 102 for executing those instructions. Thus memory resource 104 can be said to store program instructions that when executed by the processing resource 102 implement the modules described herein. Other instructions may also be utilized as will be discussed further below in other examples.

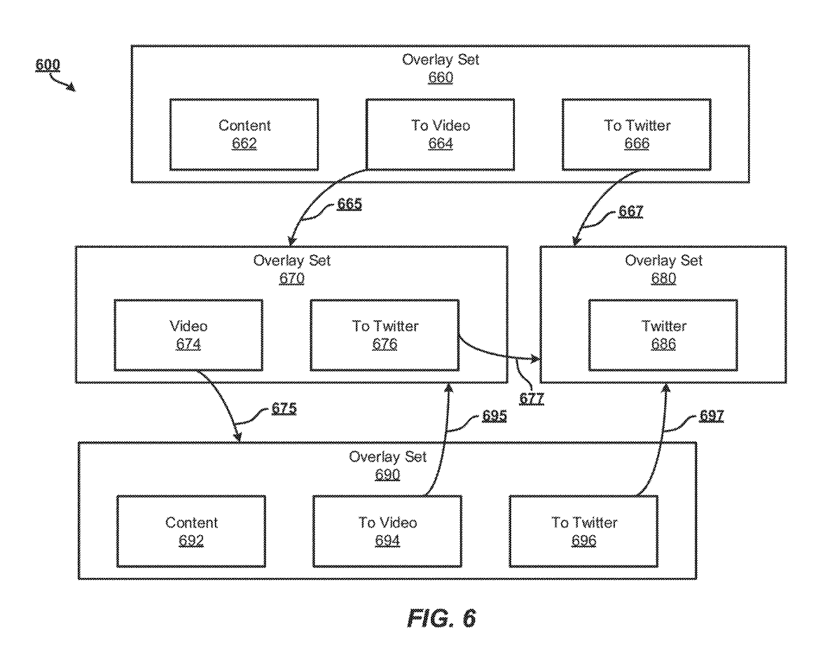

The event association instructions 120 associate an event with each of a plurality of augmented reality overlays. An overlay includes content, such as text, videos, audio, animations, and the like, which may be displayed to a user on a user computing device. Examples of groups of overlays are illustrated in FIG. 6, which is discussed below.

An event may be a user action. For example, a user may select a graphically presented option such as clicking a link or button, playing content, or other appropriate user actions that cause the computing system 100 to perform some task, action, or activity. Similarly, the event may be a system event automatically caused by the system, such as responsive to another event. For example, a system event may include performing a task, action, or activity after a predetermined period of time, after content has finished playing, or some other appropriate system event.

The event association instructions 120 associate an event, such as a particular user and/or system event, with each overlay. In this manner, the events may be used to interact with the overlays including transitioning between the overlays, sharing content from the overlays, etc.). In an example, an overlay with textual content may include a button to share the content on a social media platform. A user selecting the share button constitutes an event associated with the overlay. Similarly, an overlay may include a video. After the video is finished playing, the overlay may transition to another overlay. This also constitutes an event associated with the overlay. Many additional combinations of overlays and events is possible, and it should be understood that an overlay may include multiple events (i.e., an overlay may include links to share content with a variety of social media platforms—selecting each link may be a separate action).

The graphical representation instructions 122 display, using graph traversal techniques, the plurality of augmented reality overlays and their associated events as a graphical representation, such as to a content creator who may be creating and/or adapting the overlays on the computing system 100. The content creator may desire to view a graphical representation of the overlays so as to navigate through them, interact with them, adapt them, and the like. Graph traversal techniques may be applied to display the overlays and associated events as a graphical representation.

Graph traversal techniques utilize “nodes” and “edges” to display visual representations, such as the flow of overlay sets. A node is an individual point on a graph, and an edge connects the nodes. In the case of an augmented reality experience of the present disclosure, a node represents an group of visible overlays, while an edge represents the event connecting two visible overlay groups (i.e., nodes). For example, an edge may represent a user action or system event that causes an overlay to change visibility. A user selecting an image overlay that shows another overlay or a video coming to an end that hides the video and shows a webpage are two such examples of edges. An example of a graphical representation is illustrated in FIG, 6, as discussed below.

FIG. 2 illustrates a block diagram of another computing system 200 to graphically display overlays and associated events in augmented reality according to examples of the present disclosure. The computing system 200 may include an overlay generation module 218, an event association module 220 an overlay display module 222, and an overlay alteration module 224.

In examples, the modules described herein m y be a combination of hardware and programming instructions. The programming instructions may be processor executable instructions stored on a tangible memory resource such as a memory resource, and the hardware may include a processing resource for executing those instructions. Thus the memory resource can be said to store program instructions, that when executed by the processing resource implement the modules described herein. Other modules may also be utilized as will be discussed further below in other examples. In different implementations, more, fewer, and/or other components, modules, instructions, and arrangements thereof may be used according to the teachings described herein. In addition, various components, modules, etc. described herein may be implemented as computer-executable instructions, hardware modules, special-purpose hardware (e.g., application specific hardware, application specific integrated circuits (ASICs), and the like, or some combination or combinations of these.

The overlay generation module 218 enables generating (i.e., creating) overlays by adding content to the overlays. For example, a new overlay may be presented, which may be blank or based on a template overlay. An augmented reality experience content creator may add content to the overlay, such as text, graphics, audio, video, animation, etc. The content creator may also add links to other overlays, webpages, applications, etc.

The event association module 220 enables the content creator to associate an event or events with the generated overlays. For example, if the content creator adds a link to a social media platform to share the content on the overlay, the content creator may associate the link as an event to open the social media platform application or navigate a web browser to the social media platform webpage.

The overlay display module 222 displays, using graph traversal techniques, the plurality of augmented reality overlays and their associated events as a graphical representation, such as to the content creator who may be creating and/or adapting the overlays on the computing system 200. The content creator may desire to view a graphical representation of the overlays so as to navigate through them, interact with them, adapt them, and the like. Graph traversal techniques may be applied to display the overlays and associated events as a graphical representation.

The overlay alteration module 224 enables the content creator to alter the content of the overlays and the events associated with them. For example, a content creator may desire to add an event to an overlay after creating the overlay, or the content creator may desire to change the content on an overlay. Such alterations may be performed using the overlay alteration module 224. It should be understood that the content of an overlay and any events associated with an overlay may be altered by the overlay alteration module 224.

FIG. 3 illustrates a block diagram of a computer-readable storage medium storing instructions to graphically display overlays and associated events in augmented reality according to examples of the present disclosure. The computer-readable storage medium 304 is non-transitory in the sense that it does not encompass a transitory signal but instead is made up of one or more memory components configured to store the instructions. The computer-readable storage medium may be representative of the memory resource 104 of FIG. 1 and may store machine executable instructions in the form of modules, which are executable on a computing system such as computing system 100 of FIG. 1 and/or computing system 200 of FIG. 2.

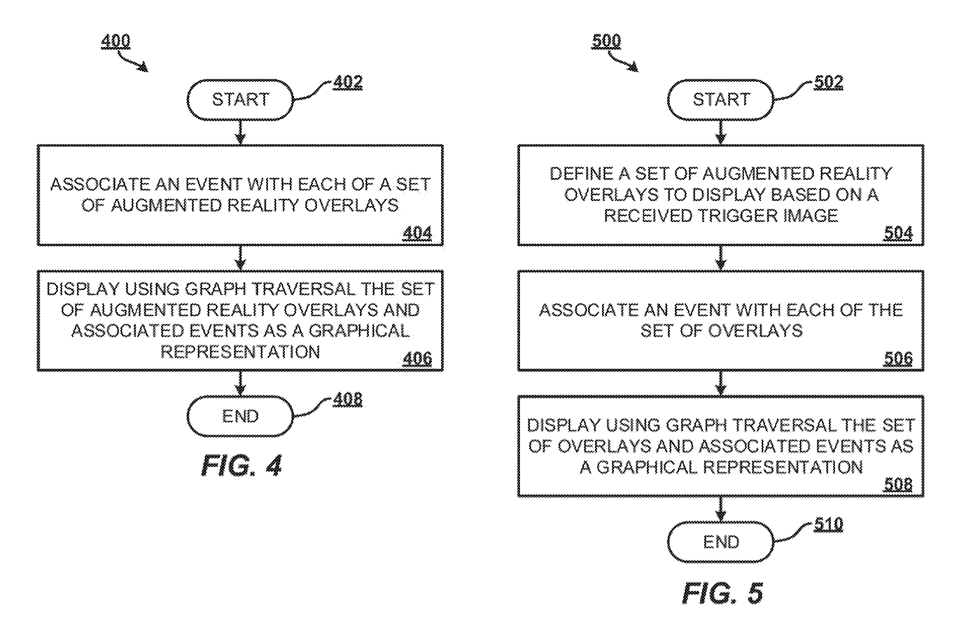

In the example shown in FIG. 3 the instructions 320, 322 may include event association instructions 320 and overlay display instructions 322. In other examples, additional instructions may be included in the computer-readable storage medium 304, such as overlay generation instructions and overlay alteration instructions. The instructions 320, 322 of the computer-readable storage medium 304 may be executable so as to perform the techniques described herein, including the functionality described regarding the method 400 of FIG. 4. While the functionality of these instructions 320, 322 is described below with reference to the functional blocks of FIG. 4, such description is not intended to be so limiting.

In particular, FIG. 4 illustrates a flow diagram of a method to graphically display overlays and associated events in augmented reality according to examples of the present disclosure. The method 400 may be stored as instructions on a non-transitory computer-readable storage medium such as computer-readable storage medium 304 of FIG. 3 or another suitable memory such as memory resource 104 of FIG. 1 that, when executed by a processor (e.g., processing resource 102 of FIG. 1), cause the processor to perform the method 400. It should be appreciated that the method 400 may be executed by a computing system or a computing device such as computing system 100 of FIG. 1 and/or computing system 200 of FIG. 2.

At block 402, the method 400 begins and continues to block 404. At block 404, the method 400 includes a computing system (e.g., computing system 100 of FIG. 1 and/or computing system 200 of FIG. 2) associating an event with each of a plurality of augmented reality overlays. The event may be used to interact with the overlays. Associating the event with each of the plurality of overlays may be performed, for example, by the event association instructions 120 and/or 320 of FIGS. 1 and 3 respectively and/or by the event association module 220 of FIG. 2. The method 400 continues to block 406.

At block 406, the method 400 includes a computing system (a, computing system 100 of FIG. 1 and/or computing system 200 of FIG. 2) displaying, using graphic traversal techniques, the plurality of augmented reality overlays and associated events as a graphical representation. Displaying the overlays and associated events as a graphical representation may be performed, for example, by the overlay display instructions 122 and/or 322 of FIGS. 1 and 3 respectively and/or by the overlay display module 222 of FIG. 2. The method 400 continues to block 408 and terminates.

Additional processes also may be included, and it should be understood that the processes depicted in FIG. 4 represent illustrations, and that other processes may be added or existing processes may be removed, modified, or rearranged without departing from the scope and spirit of the present disclosure.

FIG. 5 illustrates a flow diagram of a method 500 to graphically display overlays and associated events in augmented reality according to examples of the present disclosure. The method 500 may be stored as instructions o a non-transitory computer-readable storage medium such as computer-readable storage medium 304 of FIG. 3 or another suitable memory such as memory resource 104 of FIG. 1 that, when executed by a processor (e.g., processing resource 102 of FIG. 1), cause the processor to perform the method 500. It should be appreciated that the method 500 may be executed by a computing system or a computing device such as computing system 100 of FIG. 1 and/or computing system 200 of FIG. 2.

At block 502, the method 500 begins and continues to block 504. At block 504, the method 500 includes a computing system (e.g., computing system 100 of FIG. 1 and/or computing system 200 of FIG. 2) defining a plurality of augmented reality overlays to display based on a received trigger image. Defining the plurality of augmented reality overlays may include generating (i.e., creating) overlays by adding content and events to the overlays. Defining the plurality of augmented reality overlays may be performed, for example, by the overlay generation module 218. The method 500 continues to block 506.

At block 506, the method 500 includes a computing system (e.g., computing system 100 of FIG. 1 and/or computing system 200 of FIG. 2) associating an event with each of a plurality of augmented reality overlays. The event may be used to interact with the overlays. Associating the event with each of the plurality, of overlays may be performed, for example, by the event association instructions 120 and/or 320 of FIGS. 1 and 3 respectively and/or by the event association module 220 of FIG. 2. The event may include a user action such as a button press or link selection, playing a video, etc. as well as a system event, such as a video stopping or the expiration of a period of time. The method 500 continues to block 508.

At block 508, the method 500 includes a computing system (e.g., computing system 100 of FIG. 1 and/or computing system 200 of FIG. 2) displaying, using graphic traversal techniques, the plurality of augmented reality overlays and associated events as a graphical representation. Displaying the overlays and associated events as a graphical representation may be performed, for example, by the overlay display instructions 122 and/or 322 of FIGS. 1 and 3 respectively and/or by the overlay display module 222 of FIG. 2. In examples, displaying the plurality of overlays and associated events may include displaying one of the plurality of overlays when the one of the overlays is selected. Overlays that are transitionally next to (i.e., overlays that may be navigated or transitioned to from the currently sleeted overlay) the selected one of the overlays are displayed along with the selected one of the overlays. In this way, a content creator using an augmented reality experience creation system as described herein may select an overlay to display and may also see the other overlays that may be transitioned to from that overlay. The method 500 continues to block 510 and terminates.

Additional processes also may be included, and it should be understood that the processes depicted in FIG. 5 represent illustrations, and that other processes may be added or existing processes may be removed, modified, or rearranged without departing from the scope and spirit of the present disclosure.

FIG. 6 illustrates a graphical representation 600 of overlays and associated events as may be displayed using the techniques described according to examples of the present disclosure. In the example of FIG. 6, the visible overlay sets (or collections of visible overlays) represent nodes while the associated events represent edges as relating to the application of graph traversal techniques.

Overlay set 660 represents a first node having content 662 and links to video 664 and to twitter 660, which each represent events 66f and 667 respectively. That is, the events 665 and 667 show the flow from overlay set 660 to overlay sets 670 and 680 respectively. If the to video 684 link is selected in overlay set 660, for example, then the flow continues to overlay set 670 via the edge 665. Similarly, if the to twitter 666 link is selected in overlay set 660, the flow continues to overlay set 680 via edge 667.

Overlay set 670 represents a second node having a video 674 and a two twitter link 676. If the two twitter 676 link is selected in overlay set 670, the flow continues to overlay set 680 via edge 677. If the video is selected, the flow continues to overlay set 690, which represents a fourth node, via flow 675. Overlay set 690 may display content 692 and to video 694 and to twitter 696 links. The to video 694 link may flow back to overlay 670 via edge 695 if selected, for example. Similarly, if the to twitter 696 link is selected, the flow may continue to overlay set 680 via edge 697.

It should be understood that the graphical representation 600 of FIG. 6 illustrates only one of many possible combinations of nodes and edges and thus should not be construed as limiting but rather as illustrative.

It should be emphasized that the above-described examples are merely possible examples of implementations and set forth for a clear understanding of the present disclosure. Many variations and modifications may be made to the above-described examples without departing from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium storing instructions that, when executed by a processor, cause the processor to:
associate an event with each of a plurality of augmented reality overlays, the event being used to interact with the overlays; and
display, using graph traversal techniques, the plurality of augmented reality overlays and associated events as a graphical representation.

2. The non-transitory computer-readable storage medium of claim further storing instructions that, when executed by the processor, cause the processor to:
alter at least one of the plurality of augmented reality overlays based at least in part on the graphical representation.

3. The non-transitory computer-readable storage medium of claim 1, wherein the graphical representation includes a plurality of nodes connected by edges.

4. The non-transitory computer-readable storage medium of claim 1, further storing instructions that, when executed by the processor, cause the processor to:
generate augmented reality overlays.

5. A computing system comprising:
an overlay generation module to generate augmented reality overlays;
an event association module to associate an event with the generated overlays; and
an overlay display module to display, using graphic traversal techniques, a graphical representation of a selected overlay, any events associated with the selected overlay, and any overlays related to the events associated with the selected overlay.

6. The system of claim 5, wherein the overlay display module further enables a user of the computing system to select an overlay to be displayed.

7. The system of claim 5, further comprising:
an overlay alteration module to enable alteration of at least one of the augmented reality overlays based at least in part on the graphical representation.

8. The system of claim 5, wherein the overlay display module further displays one of the plurality of overlays when the one of the overlays is selected.

9. The system of claim wherein the overlay display module displays overlays transitionally next to the selected one of the overlays along with the selected one of the overlays.

10. The system of claim 8, wherein the graphical re presentation includes a plurality of nodes connected by edges.

11. A method comprising:
defining, by a computing system, a plurality of augmented reality overlays to display based on a received trigger image;
associating, by the computing system, an event with each of the plurality of overlays, the event being used to transition between the overlays; and
displaying, by the computing system, using graph traversal techniques, the plurality of overlays and associated events as a graphical representation.

12. The method of claim 11 wherein displaying the set of overlays and associated events includes displaying one of the plurality of overlays when the one of the overlays is selected.

13. The method of claim 12, wherein overlays transitionally next to the selected one of the overlays are displayed along with the selected one of the overlays.

14. The method of claim 11, where the event comprises a button press.

15. The method claim 11, wherein the event comprises a system event.
